(19) United States
(12) Patent Application Publication
(10) Pub. No.: US 2026/0296494 A1
(43) Pub. Date: Oct. 1, 2026

(54) AUTONOMOUS VEHICLE AND METHOD OF CONTROLLING THE SAME

(71) Applicants: Hyundai Motor Company, Seoul (KR); Kia Corporation, Seoul (KR)

(72) Inventors: Yim Ju KANG, Hwaseong-Si (KR); Dong Hun KANG, Hwaseong-Si (KR); Eung Seo KIM, Hwaseong-Si (KR); Dong Eon OH, Hwaseong-Si (KR)

(21) Appl. No.: 19/351,644

(22) Filed: Oct. 7, 2025

(30) Foreign Application Priority Data
Apr. 1, 2025 (KR) 10-2025-0042059

(51) Int. Cl. B60W 60/00; B60W 10/20; B60W 30/14; B60W 30/16; B60W 30/182; B60W 50/14; G06V 10/60; G06V 20/58

(52) U.S. Cl. CPC B60W 60/0015; B60W 10/20; B60W 30/146; B60W 30/16; B60W 30/182; B60W 50/14; B60W 60/0053; B60W 60/0059; G06V 10/60; G06V 20/58; B60W 2050/143; B60W 2050/146; B60W 2420/403; B60W 2554/802; B60W 2555/20; B60W 2556/20; B60W 2556/40; B60W 2556/45

(57) ABSTRACT

An autonomous vehicle is provided. The autonomous vehicle may include: a sensor; a transceiver; one or more processors; and a memory storing at least one instruction. The at least one instruction is configured, when executed by the one or more processors communicating with the memory, to cause the autonomous vehicle to: receive, from the sensor, vehicle traveling information of the autonomous vehicle and external object recognition information; transmit, to a server via the transceiver, the external object recognition information; receive, from the server via the transceiver, an object recognition performance indicator that indicates object recognition performance of the sensor; determine, based on the object recognition performance indicator indicating that the object recognition performance of the sensor is below a threshold level, an autonomous control strategy for the autonomous vehicle; and control, based on the autonomous control strategy, an autonomous driving operation of the autonomous vehicle.

### CROSS-REFERENCE TO RELATED APPLICATION

This application claims priority to and the benefit of Korean Patent Application No. 10-2025-0042059, filed in the Korean Intellectual Property Office on Apr. 1, 2025, the disclosure of which is incorporated herein by reference in its entirety.

### TECHNICAL FIELD

The present disclosure relates to an autonomous vehicle and a method of controlling the same.

### BACKGROUND

An autonomous vehicle operates based on a system with various sensors to detect a surrounding environment and determine a traveling route. Examples of these sensors may include cameras, lidars, radars, etc., and each sensor can exhibit optimal performance under specific environmental conditions.

However, under real-life driving conditions, recognition (e.g., object recognition) performance of a sensor may be degraded by lighting (e.g., ambient lights), weather, obstacles, age of the sensor, etc. In particular, for sensors such as cameras, the accuracy of an estimated distance (e.g., a longitudinal distance) of a detected object may be very low. Because inaccurate data that is output by a sensor can have a serious consequence on the stability, safety, and operating efficiency of autonomous vehicles, there is a need for a technology to accurately detect or measure performance degradation of a sensor in real time.

The matters described in this Background section are only for enhancement of understanding of the background of the disclosure, and should not be taken as acknowledgement that they correspond to prior art already known to those skilled in the art.

### SUMMARY

Various aspects of the disclosure provide an autonomous vehicle and a method of controlling the same, which allow sensor recognition performance of an autonomous vehicle to be evaluated in real time.

According to one or more example embodiments of the present disclosure, an autonomous vehicle may include: a sensor; a transceiver; one or more processors; and a memory storing at least one instruction. The at least on instruction may be configured, when executed by the one or more processors communicating with the memory, to cause the autonomous vehicle to: receive, from the sensor, vehicle traveling information of the autonomous vehicle and external object recognition information; transmit, to a server via the transceiver, the external object recognition information; and receive, from the server via the transceiver, an object recognition performance indicator that indicates object recognition performance of the sensor. The object recognition performance may be based on the external object recognition information. The at least on instruction may be configured, when executed by the one or more processors communicating with the memory, to further cause the autonomous vehicle to: determine, based on the object recognition performance indicator indicating that the object recognition performance of the sensor is below a threshold level, an autonomous control strategy for the autonomous vehicle; and control, based on the autonomous control strategy, an autonomous driving operation of the autonomous vehicle.

The at least one instruction is configured, when executed by the one or more processors communicating with the memory, to cause the autonomous vehicle to determine the autonomous control strategy by: changing, based on the object recognition performance indicator, at least one of: a steering control strategy of the autonomous vehicle, a speed control strategy of the autonomous vehicle, or a braking control strategy of the autonomous vehicle.

The at least one instruction may be configured, when executed by the one or more processors communicating with the memory, to cause the autonomous vehicle to determine the autonomous control strategy by: restricting a maximum speed of the autonomous vehicle based on a degree by which the object recognition performance of the sensor has degraded relative to a baseline performance value of the sensor.

The at least one instruction may be configured, when executed by the one or more processors communicating with the memory, to cause the autonomous vehicle to determine the autonomous control strategy by: increasing a safe following distance of the autonomous vehicle based on a degree by which the object recognition performance of the sensor has degraded relative to a baseline performance value of the sensor.

The at least one instruction may be configured, when executed by the one or more processors communicating with the memory, to cause the autonomous vehicle to determine the autonomous control strategy by: restricting a maximum steering angle of the autonomous vehicle based on a degree by which the object recognition performance of the sensor has degraded relative to a baseline performance value of the sensor.

The at least one instruction may be configured, when executed by the one or more processors communicating with the memory, to cause the autonomous vehicle to determine the autonomous control strategy by: disengaging an autonomous driving mode of the autonomous vehicle based on the object recognition performance of the sensor degrading by more than a threshold amount relative to a baseline performance value of the sensor.

The at least one instruction may be configured, when executed by the one or more processors communicating with the memory, to further cause the autonomous vehicle to: output, based on the object recognition performance of the sensor being below the threshold level, at least one of a visual warning signal or an auditory warning signal.

The object recognition performance of the sensor may be based on a comparison between: a measured distance, indicated by the external object recognition information, to an external object; and a reference distance, indicated by pre-stored map information, to the external object.

The object recognition performance of the sensor may be based on a comparison between: a reference detection range set indicated by pre-stored map information; and a detection range indicated by the external object recognition information received from the sensor.

The object recognition performance of the sensor may be based on at least one of: a time when the external object recognition information was received, a location of the autonomous vehicle, illumination information associated with the autonomous vehicle, or weather information.

According to one or more example embodiments of the present disclosure, a method performed by an apparatus of an autonomous vehicle may include: receiving, from a sensor of the autonomous vehicle, vehicle traveling information of the autonomous vehicle and external object recognition information; transmitting, to a server via a transceiver of the autonomous vehicle, the external object recognition information; and receiving, from the server via the transceiver, an object recognition performance indicator that indicates object recognition performance of the sensor. The object recognition performance may be based on the external object recognition information. The method may further include: determining, based on the object recognition performance indicator indicating that the object recognition performance of the sensor is below a threshold level, an autonomous control strategy for the autonomous vehicle; and controlling, based on the autonomous control strategy, an autonomous driving operation of the autonomous vehicle.

Determining the autonomous control strategy may include: changing, based on the object recognition performance indicator, at least one of: a steering control strategy of the autonomous vehicle, a speed control strategy of the autonomous vehicle, or a braking control strategy of the autonomous vehicle.

Determining the autonomous control strategy may include: restricting a maximum speed of the autonomous vehicle based on a degree by which the object recognition performance of the sensor has degraded relative to a baseline performance value of the sensor.

Determining the autonomous control strategy may include: increasing a safe following distance of the autonomous vehicle based on a degree by which the object recognition performance of the sensor has degraded relative to a baseline performance value of the sensor.

Determining the autonomous control strategy may include: restricting a maximum steering angle of the autonomous vehicle based on a degree by which the object recognition performance of the sensor has degraded relative to a baseline performance value of the sensor.

Determining the autonomous control strategy may include: disengaging an autonomous driving mode of the autonomous vehicle based on the object recognition performance of the sensor degrading by more than a threshold amount relative to a baseline performance value of the sensor.

The method may further include: outputting, based on the object recognition performance of the sensor being below the threshold level, at least one of: a visual warning signal or an auditory warning signal.

The object recognition performance of the sensor may be based on a comparison between: a measured distance, indicated by the external object recognition information, to an external object; and a reference distance, indicated by pre-stored map information, to the external object.

The object recognition performance of the sensor may be based on a comparison between: a reference detection range set indicated by pre-stored map information; and a detection range indicated by the external object recognition information received from the sensor.

The object recognition performance of the sensor may be based on at least one of: a time when the external object recognition information was received, a location of the autonomous vehicle, illumination information associated with the autonomous vehicle, or weather information.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing an example vehicle that communicates with another device to transmit and receive data;

FIG. 2 is a block diagram showing an example apparatus of a vehicle;

FIG. 3 is a block diagram showing example operations of an autonomous vehicle;

FIGS. 4, 5, 6, and 7 are views showing an example process of analyzing object recognition performance;

FIGS. 8 and 9 are views showing example operations related to a decreased recognition distance or range;

FIGS. 10A and 10B are views showing an example user interface for indicating a decrease in object recognition performance; and

FIG. 11 is a flowchart of an example method of controlling a vehicle.

### DETAILED DESCRIPTION

Hereinafter, one or more example embodiments of the present disclosure will be described in detail with reference to the accompanying drawings.

However, the technical spirit of the present disclosure is not limited to some of the described example embodiment(s), but may be implemented in various different forms, and one or more of the components among the example embodiment(s) may be used by being selectively coupled or substituted without departing from the scope of the technical spirit of the present disclosure.

In addition, terms (including technical and scientific terms) used in example embodiment(s) of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the example embodiment(s) of the present disclosure are for describing those embodiment(s) and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the example embodiment(s) of the present disclosure.

These terms are only for the purpose of distinguishing one component from another component, and the nature, sequence, order, or the like of the corresponding components is not limited by these terms.

In addition, when a certain component is described as being “connected,” “coupled,” or “joined” to another component, it may include a case in which the certain component is directly connected, coupled, or joined to another component, but also a case in which the certain component is “connected,” “coupled,” or “joined” to another component with still another component present between the certain component and another component.

In addition, when the certain component is described as being formed or disposed “on (above) or below (under)” another component, “on (above)” or “below (under)” may include not only a case in which two components are in direct contact with each other, but also a case in which one or more other components are formed or disposed between the two components. In addition, when described as “on (above) or below (under),” it may include the meaning of not only an upward direction but also a downward direction based on one component.

The term “unit” used in the present disclosure may refer to a software or hardware component such as field programmable gate array (FPGA) or an application specific integrated circuit (ASIC), and the “unit” performs certain roles. However, the “unit” is not limited to software or hardware. The “unit” may be disposed in an addressable storage medium and configured to reproduce one or more processors. Accordingly, as an example, the “unit” includes components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into a smaller number of components and “units” or separated into additional components and “units.” Additionally, the components and “units” may be implemented to reproduce one or more central processing units (CPUs) in a device or a security multimedia card.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

The expression “based” on as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining performance of object recognition) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining performance of object recognition) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining performance of object recognition) described herein.

Minimum risk maneuver (MRM) operation(s) may also be controlled, for example, based on one or more features (e.g., determining performance of object recognition) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining performance of object recognition) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., determining performance of object recognition) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining performance of object recognition) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

As described herein, a first direction may correspond to a forward direction. An object facing in the first direction may be referred to as facing “forward.” An object located further along the first direction, in relative terms, may be described as being “front.” The opposite direction of the first direction may correspond to a “backward” or “rearward” direction. An object facing in the opposite direction of the first direction may be referred to as facing “backward.” An object located further along the opposite direction of the first direction, in relative terms, may be described as being “rear.” A second direction may correspond to a leftward direction. An object facing in the second direction may be referred to as facing “left.” An object located further along the second direction, in relative terms, may be described as being “left.” The opposite direction of the second direction may correspond to a rightward direction. An object facing in the opposite direction of the second direction may be referred to as facing “rightward.” An object located further along the opposite direction of the first direction, in relative terms, may be described as being “right.” A third direction may correspond to an upward direction. An object facing in the third direction may be referred to as facing “upward.” An object located further along the third direction, in relative terms, may be described as being “up” or “top.” The opposite direction of the third direction may correspond to a “downward” direction. An object located further along the opposite direction of the third direction, in relative terms, may be described as being “down” or bottom.” Further, each of the first direction, the second direction, and the third direction may be perpendicular (e.g., orthogonal) to the remaining two directions. The first direction (or the opposite direction thereof) may be also referred to as the longitudinal direction or longitudinal orientation. The second direction (or the opposite direction thereof) may be also referred to as the lateral direction or lateral orientation. The third direction (or the opposite direction thereof) may be also referred to as the vertical direction or vertical orientation.

Hereinafter, one or more example embodiments will be described in detail with reference to the accompanying drawings, and the same or corresponding components are denoted as the same reference numeral regardless of the reference numerals, and overlapping descriptions thereof will be omitted.

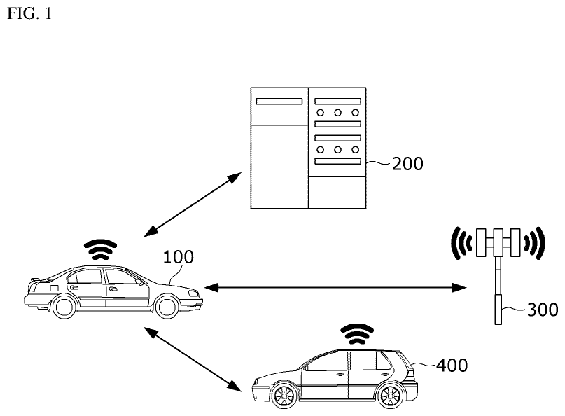

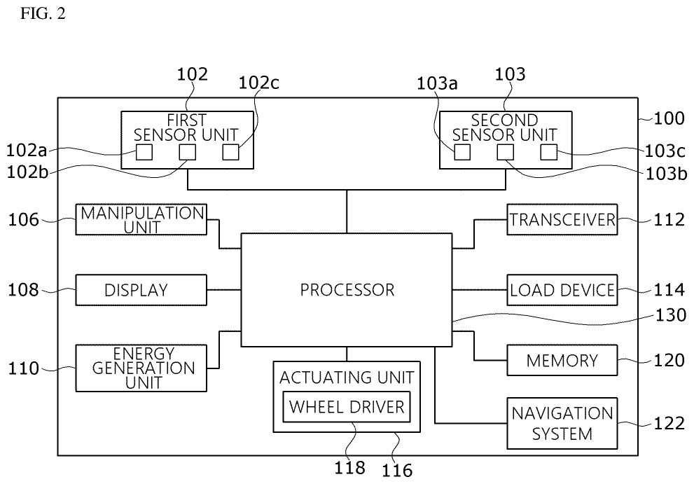

Hereinafter, a vehicle will be described with reference to FIGS. 1 and 2. FIG. 1 is a view showing an example vehicle that communicates with another device to transmit and receive data.

Referring to FIG. 1, a vehicle 100 may be driven based on electric energy or fossil energy. In the case of electric energy, the vehicle 100 may be, for example, a pure battery-based vehicle driven by only a high-voltage battery or may adopt a gas-based fuel cell as an energy source. In addition, a fuel cell may use various types of gases that may generate electric energy, and the gas may be charged to the vehicle 100, for example, in a liquefied state. Here, the gas may be, for example, hydrogen. However, the present disclosure is not limited thereto, and various gases may be applied. In the case of fossil energy, the vehicle 100 may be driven based on fuel such as gasoline, diesel, liquefied gas, etc. and provided with an internal combustion engine that drives an actuator (also referred to as an actuating unit) 116 by combustion of the fuel. The engine may be included in an energy generation unit 110 from the perspective of providing a driving rotational force of a wheel to a wheel driver 118. As another example, the vehicle 100 may drive the actuator 116 selectively using an internal combustion engine based on fossil energy and the energy of an electric battery and may be a hybrid-type vehicle.

The vehicle 100 may be a movable device. The vehicle 100 is a ground vehicle that travels on the ground and may be a typical passenger or commercial vehicle, a purpose built vehicle (PBV), etc. The vehicle 100 may be a four-wheeled vehicle, for example, a passenger car, an SUV, or a small truck, or a vehicle with more than four wheels, for example, a bus, a large truck, a container transport vehicle, a heavy equipment vehicle, etc. Here, the ground vehicle may be referred to as not only a vehicle that moves on land but also a vehicle that moves underground. The vehicle 100 may be a robot in a broad sense, such as a means of transportation, and the robot may move using wheels, tracks, or other moving modules. In the present disclosure, a ground mobility device such as a ground vehicle is mainly described, but the present disclosure also applies to air mobility devices, such as an advanced air mobility (AAM), aircraft, etc., and water mobility devices, such as a ship, a submarine, etc.

The vehicle 100 may travel under autonomous driving control, and the autonomous driving may be implemented as semi-autonomous driving or full autonomous driving. The full autonomous driving may be provided as autonomous movement in which a processor 130 of the vehicle 100 has full control authority without user intervention even when a traveling situation is uncertain. The semi-autonomous driving may be provided as autonomous movement that requires driver intervention depending on a particular traveling situation. The semi-autonomous driving may be implemented by allowing a user to perform manual driving by deactivating autonomous driving in case of situation and transferring control authority to the user. According to the level of the autonomous driving defined by the Society of Automotive Engineers (SAE), the semi-autonomous driving corresponds to autonomous driving levels 1 to 4, and the full autonomous driving corresponds to level 5.

The vehicle 100 may communicate with other devices 200 and 300 or another vehicle 400. The other devices may include, for example, a server 200 for supporting various control, state management, and traveling of the vehicle 100, an intelligent transportation system (ITS) device 300 for receiving information from an ITS, various types of user devices, etc. The server 200 may be, for example, an external device operated by a vehicle manufacturer or provided to service autonomous driving and may receive connected data of the vehicle 100 or transmit data required for autonomous driving. To support autonomous driving and various services of the vehicle 100, the server 200 may transmit various types of information and software modules that are used for controlling the vehicle 100 to the vehicle 100 in response to the request and data transmitted from the vehicle 100 and the user device.

The ITS device 300 is, for example, a road side unit (RSU) and may exchange vehicle recognition data, traveling control and state data, surrounding environmental data of a vehicle, map data, etc. with the vehicle 100 through a vehicle-to-infrastructure (V2I) to assist to a user driving his or her vehicle or support the autonomous driving of the vehicle 100. The vehicle 100 may exchange the above listed data with another vehicle 400 through a vehicle-to-vehicle (V2V) to support manual driving or autonomous driving.

The vehicle 100 may communicate with another vehicle or other devices based on cellular communication, wireless access in vehicular environment (WAVE) communication, dedicated short range communication (DSRC), short-range communication, or other communication methods.

For example, the vehicle 100 may use a communication network such as Long Term Evolution (LTE) or 5G, a Wi-Fi communication network, a WAVE communication network, etc. as a cellular communication network to communicate with the server 200, the ITS device 300, and another vehicle 400. As another example, the DSRC or the like used in the vehicle 100 may be used for communication between vehicles. A communication method between the vehicle 100, the server 200, the ITS device 300, another vehicle 400, and the user device is not limited to the example embodiment(s) disclosed herein.

FIG. 2 is a block diagram showing an example apparatus of a vehicle.

The vehicle 100 may include a sensor (also referred to as a sensor unit) 102, a manipulation unit 106, a display 108, a load device 114, and a transceiver 112.

The sensor 102 may include various types of detectors for detecting various states and situations that occur in an external environment, internal system, user manipulation, and boarding space of the vehicle 100.

Specifically, the first sensor 102 may include an outer-facing camera 102a, a lidar sensor 102b, a radar sensor 102c, etc., to recognize dynamic and static objects present outside the vehicle 100. The camera 102a may recognize an external object as an image while used in the vehicle 100 to generate image data and transmit the image data to the processor 130. The lidar sensor 104b may generate point cloud data as data of the recognized external object and transmit the point cloud data to the processor 130 in order to generate three-dimensional spatial information that identifies at least the shape of the external object. The radar sensor 102c may emit radio waves of a specific frequency to a peripheral region of the vehicle 100 to generate radar data through radio waves reflected from the external object in order to identify the presence, a relative distance, speed, direction, etc. of the external object. In the present disclosure, the lidar sensor 102b is provided as an example, but in another example, the lidar sensor 102b may not be mounted.

The first sensor 102 may generate object recognition information based on sensing data. The object recognition information may include information about whether an object is present, position information of the object, distance information between the vehicle 100 and the object, and relative speed information between the vehicle 100 and the object. The external object may be various objects related to the driving of the vehicle 100.

A second sensor unit 103 may include a positioning sensor 103a, a wheel sensor 103b, an attitude sensor 103c, etc. to check a position, speed, driving attitude, etc., of the vehicle. The attitude sensor 103c may include a gyro sensor, an angular velocity sensor, an acceleration sensor, etc. The attitude sensor may be an inertial measurement unit (IMU) sensor and may include a 3-axis accelerometer and a 3-axis angular velocity meter. The attitude sensor may measure acceleration in a progress direction x of the vehicle 100, acceleration in a transverse direction y, acceleration in a height direction z, and yaw, pitch, and roll as an angular speed of the vehicle.

The second sensor unit 103 may generate vehicle traveling information based on the sensing data. The vehicle traveling information may be information generated based on data detected by various sensors installed in the vehicle. For example, the vehicle traveling information may include vehicle attitude information, vehicle speed information, vehicle tilt information, vehicle weight information, vehicle direction information, vehicle battery information, vehicle fuel information, vehicle tire pressure information, vehicle steering information, vehicle room temperature information, vehicle room humidity information, pedal position information, vehicle engine temperature information, etc.

In addition, the vehicle traveling information may include route information. The route information may be information generated based on a destination input by a vehicle user through the manipulation unit 106. The route information may be information in which a traveling route from a current position of a host vehicle to a destination is displayed on map information when the destination is set. When the destination is not set, the route information may be information that includes a road on which the vehicle is currently traveling and a future traveling route including the road.

The manipulation unit 106 may be configured as a module manipulated by a user for driving. For example, the manipulation unit 106 may be a steering wheel for manual driving, an automatic or manual transmission, an accelerator pedal, a brake pedal, etc. The manipulation unit 106 may further include an interface for using, deactivating, and selecting a specific function of an autonomous driving mode requested by the user so that the user may use the autonomous driving function. To receive various requests related to autonomous driving, the manipulation unit 106 may be composed of, for example, a hard type interface provided at a predetermined location in the vehicle 100 or a soft type interface that may be touched on the display 108. According to specifications of the autonomous driving vehicle, at least one of the steering wheel, the transmission, and the pedals may be omitted. As another example, the manipulation unit 106 may include a module that receives a control request of the user for the load device 114 in addition to driving control.

The display 108 may serve as a user interface. The display 108 may be controlled by the processor 130 to visually and audibly output an operation state, control state, route/traffic information, and the remaining energy information of the vehicle 100, a content requested by a driver, etc. In addition, the display 108 may be formed as a touch screen capable of detecting the input of the driver to receive the request of the driver that instructs the processor 130.

The load device 114 may be mounted on the vehicle 100 and may be a type of non-driving electric device not including a driving power system such as the wheel driver 118 and the like. The load device 114 is an auxiliary device for receiving power from the energy generation unit 110 and may be, for example, various devices installed on an air conditioning system, a lighting system, a seat system, and the vehicle 100. In the present disclosure, a cooling/heating system for cooling or heating at least one of a battery, a fuel cell, an internal combustion engine, an air conditioning system, and a specific portion of the vehicle 100 may be further included.

The transceiver 112 may support mutual communication with the server 200, the ITS device 300, a nearby vehicle 400, etc. The transceiver 112 may include, for example, a module for processing cellular communication, WAVE, DSRC communication, etc. In the present disclosure, the transceiver 112 may transmit data generated or stored during driving to the server 200 and receive data and a software module transmitted from the server 200. The transceiver 112 may support communication with an electronic device of a passenger in the vehicle 100. In the present disclosure, the vehicle 100 may transmit and receive data used in the method according to the present disclosure with an external device through the transceiver 112.

For example, the transceiver 112 may receive traffic signal information from a traffic signal controller and provide the traffic signal information to the processor 130. In addition, the transceiver 112 may receive a control signal information from the traffic signal controller and provide the control signal to the processor 130.

In addition, the vehicle 100 may include the energy generation unit 110 and the actuator 116.

The energy generation unit 110 may generate and supply power and electric power that are used in a driving power system and a non-driving power system, such as the actuator 116. The non-driving power system may include, for example, the sensor 102, the manipulation unit 106, the display 108, the load device 114, the transceiver 112, etc., but is not limited thereto, and may include various components for implementing sensing, interface, communication, and convenience functions other than components directly involved in a driving operation. When the vehicle 100 is driven based on electric energy, the energy generation unit 110 may be provided as, for example, an electric battery charged from the outside or provided as a combination of an electric battery and a fuel cell that charges the battery. In the case of a combination of the electric battery and the fuel cell, the energy generation unit 110 may include a tank for storing a material used to produce power of the fuel cell, for example, liquefied hydrogen. When the vehicle 100 is driven based on fossil energy, the energy generation unit 110 may be configured as an internal combustion engine. In addition, when the vehicle 100 is a hybrid type, the energy generation unit 110 may be provided as a combination of the internal combustion engine and the electric battery.

The actuator 116 may include at least one module that implements a driving operation and perform at least one driving operation of longitudinal control such as acceleration and deceleration and transverse control such as steering according to a user request from the manipulation unit 106. To perform the driving operation according to the manual manipulation of the user or the instruction of the processor 130 according to autonomous driving, the actuator 116 may include the wheel driver 118, and a mechanical component and electronic module for implementing the driving operation of the wheel driver 118. When the vehicle 100 is operated based on electric energy, the vehicle 100 may include an assembly for transmitting the requested driving operation to the wheel driver 118. When the vehicle 100 is operated based on fossil energy, the actuator 116 may include a transmission and a gear module for transmitting the power of an internal combustion engine.

The wheel driver 118 may include a plurality of wheels, a driving force generation module for generating a driving force to impart the driving force to wheels or transmitting the driving force, a brake module for decelerating the driving of the wheels, a steering module for achieving transverse control of the wheels, etc. When the vehicle 100 is driven based on electric energy, the driving force generation module may be provided as a motor assembly for generating a driving force based on power output from the electric battery. The brake module of the electricity-based vehicle 100 may further have a regenerative brake function.

A navigation system 122 may provide navigation information. The navigation information may include at least one of map information, set destination information, route information according to destination setting, information about various objects on a route, lane information, and current position information of the vehicle.

The navigation system 122 may receive information from an external device through the transceiver 112 and update pre-stored information. The navigation system 122 may be classified as a subcomponent of the manipulation unit 106.

In addition, the vehicle 100 may include a memory 120 and the processor 130.

The memory 120 may store applications and various types of data for controlling the vehicle 100 and load the applications or read or write the data at the request of the processor 130.

The processor 130 may perform the overall control of the vehicle 100. The processor 130 may be configured to execute applications and instructions that are stored in the memory 120.

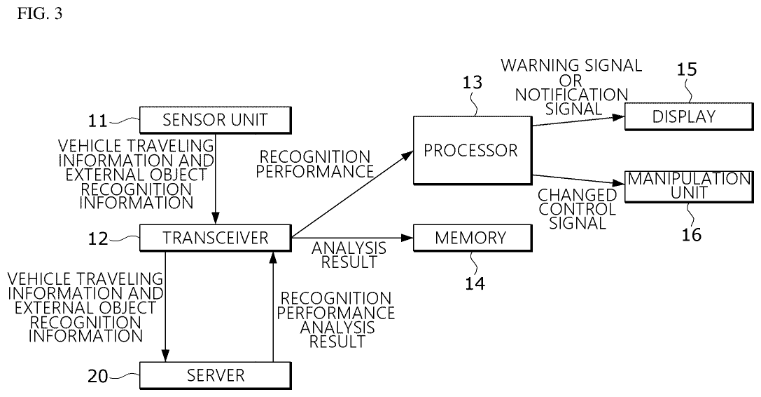

FIG. 3 is a block diagram showing example operations of an autonomous vehicle. Referring to FIG. 3, an autonomous vehicle 10 may include a sensor unit 11, a transceiver 12, a processor 13, and a memory 14. The sensor unit 11, the transceiver 12, the processor 13, and the memory 14 of FIG. 3 may be the same component as the sensor unit, the transceiver, the processor, and the memory of FIG. 2, respectively. In addition, a server 20 of FIG. 3 may be the same component as the server of FIG. 1, and a display 15 and a manipulation unit 16 of FIG. 3 may be the same component as the display and the manipulation unit of FIG. 2.

The sensor unit 11 may collect vehicle traveling information and external object recognition information of a host vehicle.

The external object recognition information may include information about the presence or absence of an object, position information of an object, distance information between the vehicle and the object, and relative speed information between the vehicle and the object. The external objects may be various objects related to the operation of the vehicle.

In addition, the vehicle traveling information of the host vehicle may include vehicle attitude information, vehicle speed information, vehicle tilt information, vehicle weight information, vehicle direction information, vehicle battery information, vehicle fuel information, vehicle tire pressure information, vehicle steering information, vehicle room temperature information, vehicle room humidity information, pedal position information, vehicle engine temperature information, etc.

In addition, the vehicle traveling information of the host vehicle may include route information. The route information may be information generated based on a destination input by a vehicle user through the manipulation unit. The route information may be information in which a traveling route from a current position of a host vehicle to a destination is displayed on map information when the destination is set. When the destination is not set, the route information may be information that includes a road on which the vehicle is currently traveling and a future traveling route including the road.

The transceiver 12 may transmit the external object recognition information to the server and receive a recognition performance analysis result that has analyzed the recognition performance of the sensor unit based on the external object recognition information from the server. The external object recognition information may include identification information that may classify the sensor unit.

The server 20 may analyze the recognition performance of the sensor unit 11 based on a recognition distance of the external object included in the external object recognition information and a reference recognition distance of the external object included in the pre-stored map information. The recognition distance of the external object may also be referred to as a detected (e.g., measured, estimated, etc.) distance to the external object. The recognition distance may be the distance to the target object as detected (e.g., measured, estimated, etc.) by the sensor.

In addition, the server 20 may compare a reference detection range set using the pre-stored map information with a detection range calculated using the external object recognition information collected from the sensor unit 11 to analyze the recognition performance of the sensor unit 11.

The recognition performance of the sensor unit 11 may refer to data that quantifies percentages of detection distances and detection ranges of a camera, a lidar, a radar, an ultrasonic sensor, etc., to average performance data through their comparison.

The server 20 may classify the type of sensor according to the identification information of the sensor unit 11, compare the performance of the classified sensor with each reference detection range, and analyze the recognition performance. The server 20 may analyze the recognition performance, generate a recognition performance analysis result based on the result of the analysis, and transmit the recognition performance analysis result to the transceiver 12 of the autonomous vehicle.

The recognition performance analysis result may be data that quantifies a degree to which the detection distance and detection range of the corresponding sensor are consistent with the reference detection range collected and analyzed from a plurality of vehicles.

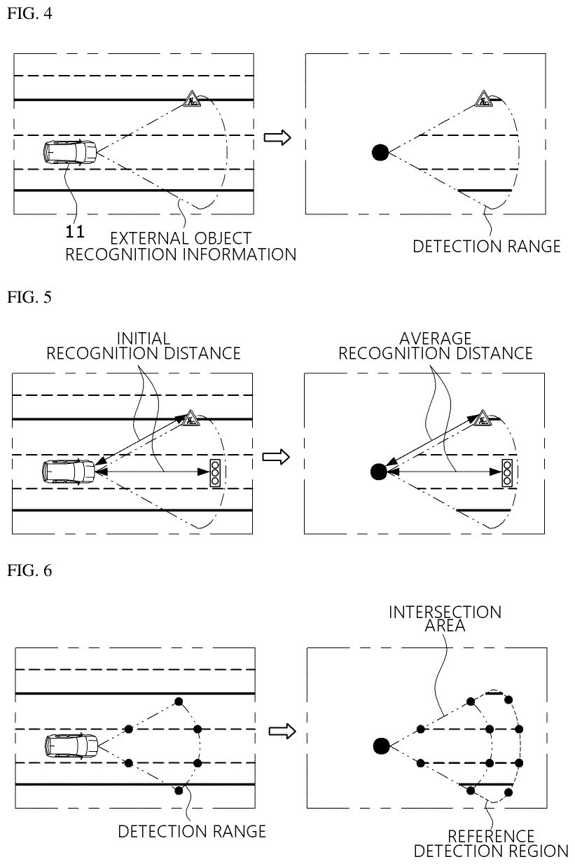

FIGS. 4, 5, 6, and 7 are views showing an example process of analyzing object recognition performance.

Referring to FIG. 4, the server 20 may collect external object recognition information from the plurality of vehicles and update map information.

The sensor unit 11 of the vehicle may collect data on a surrounding environment during travel to collect the external object recognition information. The external object recognition information may include external objects (e.g., vehicles, pedestrians, obstacles, lanes, etc.) and location information thereof.

The transceiver 12 may transmit the vehicle traveling information and the external object recognition information to the server 20.

The server 20 may define the detection range of the sensor unit 11 based on an outermost object point among objects detected by the sensor unit 11. Here, the outermost object point may refer to a location of an object at the farthest distance that the sensor unit 11 may detect among the objects included in the external object recognition information.

The server 20 may analyze real-time data sent by the vehicle, calculate a detection range, and compare the calculated detection range with the pre-stored map information. When the sensor unit 11 detects a specific object but the specific object is not present in the map information, the server 20 may determine that the specific object is a new object and update the map information. Accordingly, the server 20 may store the location and sensor range of the external object detected by the sensor unit 11 at a specific location and update the map information.

For example, the server 20 may set a reference recognition distance and a reference detection range by averaging values of a plurality of pieces of external object recognition information collected at the same location. For example, the server 20 may calculate the distribution of the plurality of pieces of external object recognition information and then filter a predetermined number of pieces of external object recognition information distributed at upper and lower limits of the distribution. The server 20 may set the reference recognition distance and reference detection range with an average value of the pieces of the external object recognition information remaining after filtering.

The server 20 compares the real-time external object recognition information received from the vehicle with the map information continuously updated through the external object recognition information of the plurality of vehicles. The map information is information generated by integrating the pieces of external object recognition information received from the plurality of vehicles and may reflect a general environment and location of an object of a corresponding region.

The server 20 may determine a recognition distance at which a specific sensor may recognize a specific external object at a specific location using the map information and set the recognition distance as the reference recognition distance. In addition, the server 20 may determine the detection range in which a specific sensor may detect a plurality of external objects at a specific location using the map information and set the detection range as the reference detection range.

The server 20 may reflect at least one of the time when the external object recognition information is collected, a location of a vehicle, illumination information, and weather information to set the reference recognition distance and the reference detection range.

The server 20 may reflect at least one of a time, a location of a vehicle, illumination information, and weather information that are collected in the external object recognition information to set the reference recognition distance and the reference detection range. The server 20 may collect weather information and illumination information based on a current location of the vehicle and the collection time included in the vehicle traveling information and set the reference recognition distance and the reference detection range using the external object recognition information that matches the corresponding weather information and collected information.

For example, on a rainy or foggy day, the performance of radar and lidar may decrease, and the detection range and performance may vary depending on a size of the vehicle and an installation location of the sensor. For example, since the sensor is installed at a higher location in an SUV than in a passenger car, the recognition distance may increase or the detection range may extend further.

That is, the server 20 may set the reference recognition distance and the reference detection range based on big data of the previously collected external object recognition information. The server 20 may determine the location and collection time of the vehicle using the vehicle traveling information and external object recognition information transmitted from the transceiver 12, extract only the external object recognition information matching the location and collection time of the vehicle, and set the reference recognition distance and the reference detection range.

Referring to FIG. 5, the server 20 may analyze the recognition performance of the sensor unit 11 using static objects such as signs and traffic lights among the external object recognition information.

The server 20 may compare the data received from the vehicle with the pre-stored real-time update map information.

The map information is information constructed by integrating the pieces of external object recognition information of the plurality of vehicles and may include the maximum recognition distance of a specific external object (e.g., a specific sign). For example, the map information may include data indicating that the same child protection sign has been detected at an average distance of 80 m from a plurality of other vehicles at a specific location.

The server 20 may compare a distance at which a specific external object was first recognized in the external object detection information of the sensor unit 11 with the average recognition distance recorded in the map information. The server 20 may calculate an initial recognition distance reported by a current vehicle as a percentage based on the average recognition distance.

For example, when an average recognition distance of a specific traffic light in the map information is 100 m and the sensor unit 11 of the host vehicle first recognizes the same traffic light at a distance of 70 m, the recognition performance of the corresponding sensor may be calculated to be 70%.

For example, when the sensor unit 11 of the host vehicle recognizes a child protection sign at a distance of 30 m and the average recognition distance for the same child protection sign in the map information is 80 m, the recognition performance of the corresponding sensor may be calculated to be 37.5% (=30 m/80 m*100).

The server 20 may compare the initial recognition distance for the external object in the external object recognition information transmitted from the transceiver 12 with the average recognition distance in the map information, quantify the recognition performance of each distance, and transmit the quantified recognition performance as a recognition performance analysis result.

For example, when a plurality of objects are present in the external object recognition information, the server 20 may calculate the average value of the recognition performance for each object and transmit the calculated average value as a recognition performance analysis result.

Referring to FIG. 6, the server 20 may analyze the recognition performance of the sensor unit 11 using lane recognition information of the external object recognition information.

The sensor unit 11 may detect the surrounding environment during travel, recognize the lane and object on a road, generate external object recognition information, and transmit the generated external object recognition information to the server 20 through the transceiver 12.

The server 20 may compare the external object recognition information transmitted from the vehicle with the pre-stored real-time update map information. The map information is information generated by integrating the pieces of external object recognition information of the plurality of vehicles and may include an area of a lane and outermost point information of a specific region. The outermost point can be defined as a lane boundary at the farthest distance that the sensor may detect. The server 20 may set the reference detection range using the outermost point of the map information as a boundary.

In addition, the server 20 may extract the outermost point from the external object recognition information received from the transceiver 12 and calculate the detection range of the sensor unit 11 using the outermost point as a boundary.

The server 20 may compare the detection range of the sensor unit 11 with the reference detection range of the map information and determine (e.g., calculate) a percentage of an intersecting area of the detection range to the reference detection range. The server 20 may analyze that the recognition performance of the sensor unit 11 is better as the calculated percentage of the intersecting area is higher.

When the detection range of the sensor unit 11 is good, the percentage of the intersecting area may be calculated to be 100% within an error range. However, when the detection range of the sensor unit 11 is reduced or distorted, the percentage of the intersecting area may be calculated to be less than 100%.

For example, when an area of the reference detection range set based on the lane on the map information is 100 m² and an area of the detection range calculated based on the lane detected by the sensor unit 11 is 80 m², the percentage of the intersecting area may be calculated to be 80%. The server 20 may calculate the percentage of the intersecting area to be the recognition performance of the sensor unit 11.

The server 20 may transmit the recognition performance analysis results including the detection range, the reference detection range, and the above percentages of the areas to the transceiver 12 of the autonomous vehicle.

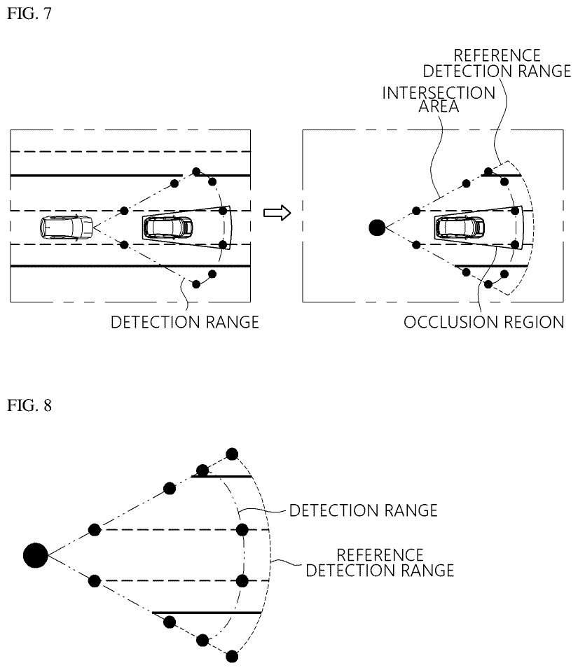

Referring to FIG. 7, the server 20 may analyze the recognition performance of the sensor unit 11 using lane recognition information of the external object recognition information.

The server 20 may determine an occlusion region in the region detected by the sensor unit 11. The occlusion region may be a shaded area that is not detected due to an obstacle (e.g., a vehicle, a building, a tree, etc.) that obstructs the view among the entire detection range of the sensor unit 11.

The server 20 may determine the occlusion region using a radial angle of a camera with respect to the closest point between the vehicle and the obstacle (a location at which the sensor recognizes the closest point to the obstacle). The server 20 may determine the occlusion region by transforming coordinates of the obstacle through a bird's eye view (BEV) transformation technique and analyzing the coordinates of the obstacle in a projection manner looking down from the top of the vehicle.

The server 20 may extract the outermost point from the external object recognition information and calculate the detection range of the sensor unit 11 using the outermost point as a boundary. The server 20 may calculate an actual detection range by excluding the occlusion region from the detection range.

In addition, the server 20 may calculate the reference detection range by excluding the same occlusion region on the map information. That is, the server 20 may calculate the occlusion region using the external object recognition information of the sensor unit 11 received in real time and calculate the reference detection range by excluding the occlusion region on the map information.

The server 20 may compare the actual detection range excluding the occlusion region with the reference detection range of the map information and calculate a percentage of an intersecting area of the actual detection range to the reference detection range. The server 20 may analyze that the recognition performance of the sensor unit 11 is better as the calculated percentage of the intersecting area is larger.

When the detection range of the sensor unit 11 is good, the percentage of the intersecting area may be calculated to be 100% within an error range. However, when the detection range of the sensor unit 11 is reduced or distorted, the percentage of the intersecting area may be calculated to be less than 100%.

For example, when an area of the reference detection range set based on the lane on the map information is 100 m² and an area of the detection range calculated based on the lane detected by the sensor unit 11 is 80 m², the percentage of the intersecting area may be calculated to be 80%. The server 20 may calculate the percentage of the intersecting area to be the recognition performance of the sensor unit 11.

The server 20 may transmit the recognition performance analysis results including the detection range, the reference detection range, and the above percentages of the areas to the transceiver 12 of the autonomous vehicle.

The processor 13 may change a control strategy of the vehicle based on the result of the recognition performance analysis when the recognition performance of the sensor unit 11 exceeds a preset reference percentage. The processor 13 may generate a control signal according to the changed control strategy and transmit the control signal to the manipulation unit 16.

The processor 13 may change at least one of a steering control strategy, speed control strategy, and braking control strategy of the vehicle based on a percentage of the recognition performance of the sensor unit 11 that exceeds the reference recognition distance or the reference detection range. For example, the processor 13 may change the control strategy of the vehicle when the recognition performance of the sensor unit 11 is reduced to 90% or less.

The processor 13 may limit (e.g., restrict) the maximum speed of the vehicle in proportion to a percentage of the reduced recognition performance of the sensor unit 11 to the reference recognition distance or the reference detection range. When the recognition performance of the sensor unit 11 is 90%, the processor 13 may limit the maximum speed applied in an autonomous driving mode to 90%. For example, when the recognition performance of the sensor unit 11 received from the server 20 is 90%, the processor 13 may limit the maximum speed applied in the autonomous driving mode from 100 km/h to 90 km/h.

The processor 13 may increase a safety distance of the vehicle in proportion to the percentage of the reduced recognition performance of the sensor unit 11 to the reference recognition distance or the reference detection range. The safety distance (also referred to as a safe following distance) may be a distance (e.g., minimum distance) that the host vehicle (e.g., autonomous vehicle) attempts to keep between itself and a leading vehicle. When the recognition performance of the sensor unit 11 is 90%, the processor 13 may limit the safety distance applied in the autonomous driving mode to 90%. For example, when the recognition performance of the sensor unit 11 received from the server 20 is 90%, the processor 13 may increase the safety distance applied in the autonomous driving mode from 100 m to 110 m. That is, the processor 13 may change the braking control strategy of the vehicle by adjusting the safety distance of the vehicle.

The processor 13 may limit the maximum steering angle of the vehicle in proportion to a percentage of the reduced recognition performance of the sensor unit 11 to the reference recognition distance or the reference detection range. When the recognition performance of the sensor unit 11 is 90%, the processor 13 may limit the maximum steering angle applied in an autonomous driving mode to 90%. For example, when the recognition performance of the sensor unit 11 received from the server 20 is 90%, the processor 13 may limit the maximum steering angle of outer wheels or inner wheels applied in the autonomous driving mode from 40 degrees to 36 degrees.

The processor 13 may determine a direction in which the reference recognition distance or the reference detection range is reduced and change at least one of the steering control strategy, the speed control strategy, and the braking control strategy.

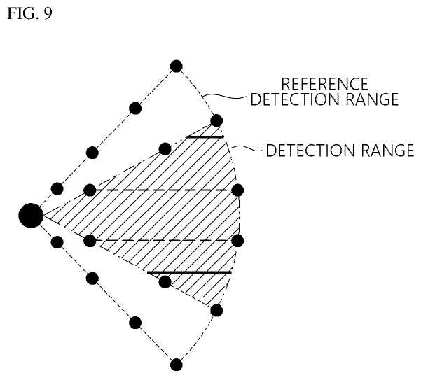

FIGS. 8 and 9 are views showing example operations related to a decreased recognition distance or range.

Referring to FIG. 8, the processor 13 may change at least one of the speed control strategy and the braking control strategy when the decrease in the recognition distance or the detection range occurs in the same lane as a traveling lane of the host vehicle. That is, when it is determined that the recognition performance is degraded only in a longitudinal direction of the vehicle and is not in a transverse direction, the processor 13 may change at least one of the speed control strategy and the braking control strategy without changing the steering control strategy.

Referring to FIG. 9, when the decrease in the recognition distance or the detection range occurs in a lane other than the traveling lane of the host vehicle, the processor 13 may change the steering control strategy. That is, when it is determined that the recognition performance is degraded only in the transverse direction of the vehicle and is not in the longitudinal direction, the processor 13 may change only the steering control strategy without changing the speed control strategy and the braking control strategy.

The processor 13 may determine the direction in which the recognition performance is degraded by using the detection object coordinates, detection range, reference detection range, and percentage of the area of the sensor unit 11, which are included in the recognition performance analysis result.

The processor 13 may terminate (e.g., disengage) the autonomous driving mode of the vehicle when the percentage of the recognition performance of the sensor unit 11 that exceeds the reference recognition distance or the reference detection range exceeds a preset allowable limit. When the recognition performance of the sensor unit 11 has been degraded to the extent that it is determined that safe driving cannot be ensured through a change in control strategy, the processor 13 may perform an operation of terminating (e.g., disengaging) the autonomous driving mode and transferring the control authority to the driver without changing the control strategy.

In addition, when the recognition performance of the sensor unit 11 is degraded to the preset reference percentage or less, the processor 13 may output at least one of a visual warning signal and an auditory warning signal.

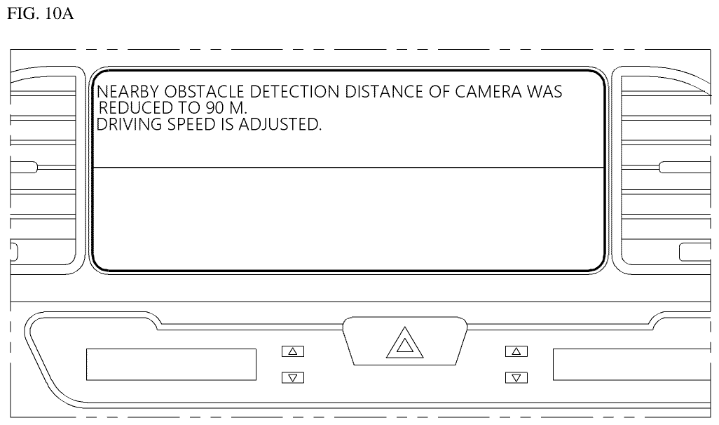

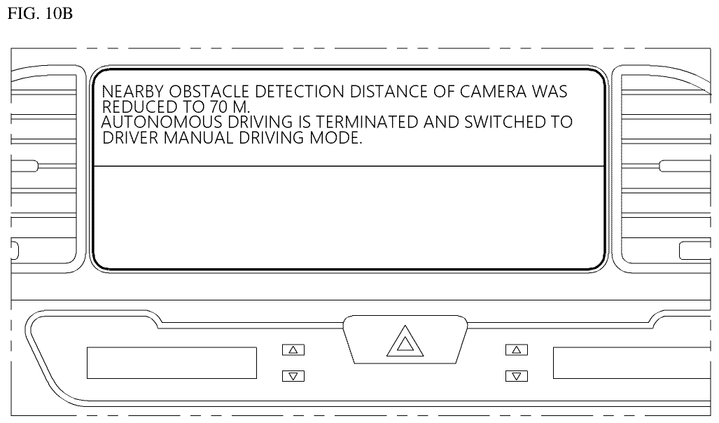

FIGS. 10A and 10B are views showing an example user interface for indicating a decrease in object recognition performance. Referring to FIG. 10, the processor 13 may display the degree of the degraded recognition performance of the sensor unit 11 using visual signals, such as letters, numbers, symbols, figures, or pictures, through the display 15. At the same time, the processor 13 may generate the degree of the degraded recognition performance as a voice signal and output an auditory signal through the display 15. FIG. 10A illustrates a display screen displaying a message for adjusting a driving speed according to a decrease in a camera's detection distance of surrounding obstacles, and FIG. 10B illustrates a display screen displaying a message for terminating autonomous driving according to a decrease in the camera's detection distance of surrounding obstacles.

In addition, when the recognition performance of the sensor unit 11 is degraded to 70% or less, the processor 13 may output a notification signal to terminate (e.g., disengage) the autonomous driving mode and transfer the control authority to the driver along with the warning signal. When the driver does not perform manual driving within a preset time from an output time point of the notification signal, the processor 13 may identify the closest parking zone on a driving route and forcibly perform emergency parking. At this time, the processor 13 may determine whether the driver intervenes using the vehicle traveling information, such as a speed, acceleration, steering angle, brake pedal operation, etc. of the vehicle. In addition, the processor 13 may identify the parking zone using the map information of the navigation system or the external object recognition information of the sensor unit 11.

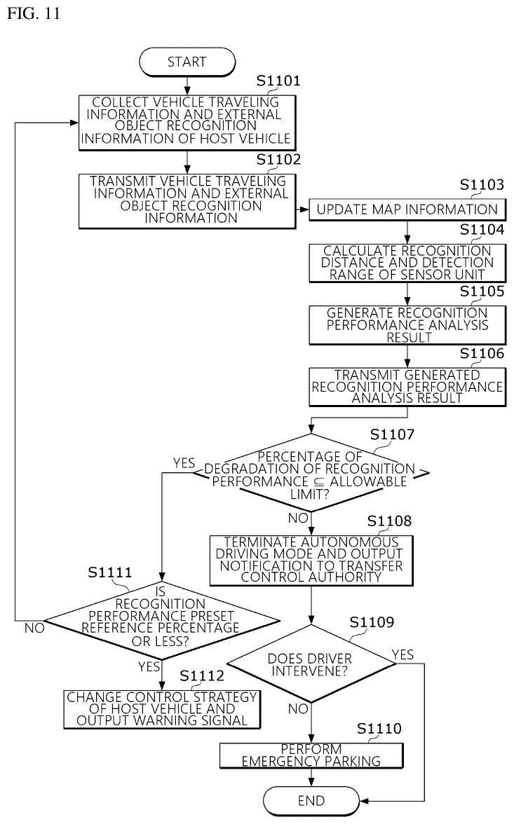

FIG. 11 is a flowchart of an example method of controlling a vehicle. Referring to FIG. 11, the sensor unit collects vehicle traveling information and external object recognition information of the host vehicle (S1101).

The transceiver transmits the external object recognition information to the server (S1102).

The server updates map information using the external object recognition information (S1103).

The server analyzes the external object recognition information and calculates the recognition distance and detection range of the sensor unit (S1104).

The server compares at least one of the recognition distance and detection range of the sensor unit with the reference recognition distance and reference detection range of the map information, respectively, analyzes the recognition performance of the sensor unit, and generates the analyzed recognition performance as a recognition performance analysis result. For example, the server analyzes the recognition performance of the sensor unit based on the recognition distance of the external object included in the external object recognition information and the reference recognition distance of the external object included in the pre-stored map information. Alternatively, the server compares the reference detection range set using the pre-stored map information with the detection range calculated using the external object recognition information collected from the sensor unit to analyze the recognition performance of the sensor unit. For example, the server reflects at least one of the time when the external object recognition information was collected, the location of the vehicle, the illumination information, and the weather information to analyze the recognition performance of the sensor unit (S1105).

The server transmits the generated recognition performance analysis result to the transceiver (S1106).

If the percentage of the degradation in the recognition performance of the sensor unit exceeds the preset allowable limit (e.g., if the percentage by which the object recognition performance of the sensor has degraded beyond a threshold level), the processor outputs the notification signal to terminate (e.g., disengage) the autonomous driving mode and transfer the control authority to the driver (S1107 and S1108).

The processor determines whether the driver intervenes, identifies the closest parking zone on the driving route when the driver does not perform manual driving within the preset time from the output time point of the notification signal, and forcibly performs emergency parking (S1109 and S1110).

Alternatively, when it is determined based on the recognition performance analysis result that the recognition performance of the sensor unit is degraded to the preset reference percentage or less, the processor changes the control strategy of the host vehicle. If the percentage of the degradation in the recognition performance of the sensor unit does not exceed the preset allowable limit but is decreased to the reference percentage or less, the processor changes the control strategy. For example, the processor may limit (e.g., restrict) the maximum speed of the vehicle in proportion to the percentage of the degradation in the recognition performance of the sensor unit (e.g., based on a degree by which the object recognition performance of the sensor has degraded relative to a baseline performance value of the sensor). Alternatively, the processor increases the safety distance of the vehicle in proportion to the percentage of the degradation in the recognition performance of the sensor unit. Alternatively, the processor limits the maximum steering angle of the vehicle in proportion to the percentage of the degradation in the recognition performance of the sensor unit. At the same time, the processor outputs information about the performance degradation of the sensor unit as at least one of a visual warning signal and an auditory warning signal (S1111 and S1112).

According to an autonomous vehicle and a method of controlling the same according to the present disclosure, recognition performance of a current sensor can be evaluated through a comparison with existing average recognition distance data by comparing and analyzing sensor data collected in real time with map data of a server.

In addition, by comparing an average sensor recognition distance data with a current sensor recognition data, the degradation of performance of the sensor can be detected in real time.

In addition, it is possible to improve the reliability of the sensor data of the autonomous vehicle and support safe traveling.

Accordingly, the performance of the sensor of the autonomous vehicle can be continuously monitored to detect an abnormal situation in real time, which can contribute to enabling safer and more efficient traveling.

There is provided an autonomous vehicle including a sensor unit, a transceiver, one or more processors, and a memory configured to store one or more programs executed by the one or more processors, wherein the sensor unit collects vehicle traveling information and external object recognition information of a host vehicle, the transceiver transmits the external object recognition information to a server and receives a recognition performance analysis result that has analyzed recognition performance of the sensor unit based on the external object recognition information from the server, and when it is determined based on the recognition performance analysis result that the recognition performance of the sensor unit is degraded to a preset reference percentage or less, the processor changes a control strategy of the host vehicle.

The processor may change at least one of a steering control strategy, a speed control strategy, and a braking control strategy of the vehicle based on the recognition performance analysis result.

The processor may limit a maximum speed of the vehicle in proportion to a percentage of the degradation in the recognition performance of the sensor unit.

The processor may increase a safety distance of the vehicle in proportion to a percentage of the degradation in the recognition performance of the sensor unit.

The processor may limit a maximum steering angle of the vehicle in proportion to a percentage of the degradation in the recognition performance of the sensor unit.

The processor may terminate an autonomous driving mode of the vehicle based on a percentage of the degradation in the recognition performance of the sensor unit exceeds a preset allowable limit.

When the recognition performance of the sensor unit is degraded to a preset reference percentage or less, the processor may output at least one of a visual warning signal and an auditory warning signal.

The server may analyze the recognition performance of the sensor unit based on a recognition distance of an external object included in the external object recognition information and a reference recognition distance of an external object included in pre-stored map information.

The server may compare a reference detection range set using pre-stored map information with a detection range calculated using the external object recognition information collected from the sensor unit to analyze the recognition performance of the sensor unit.

The server may reflect at least one of a time when the external object recognition information was collected, a location of the vehicle, illumination information, and weather information to analyze the recognition performance of the sensor unit.

There is provided a method of controlling a vehicle, which is performed using a sensor unit, a transceiver, and a computing device including one or more processors and a memory configured to store one or more programs executed by the one or more processors, which includes collecting, by the sensor unit, vehicle traveling information and external object recognition information of a host vehicle, transmitting, by the transceiver, the external object recognition information to a server and receiving a recognition performance analysis result that has analyzed recognition performance of the sensor unit based on the external object recognition information from the server, and when it is determined based on the recognition performance analysis result that the recognition performance of the sensor unit is degraded to a preset reference percentage or less, changing, by the processor, a control strategy of the host vehicle.

The processor may change at least one of a steering control strategy, a speed control strategy, and a braking control strategy of the vehicle based on the recognition performance analysis result.

The processor may limit a maximum speed of the vehicle in proportion to a percentage of the degradation in the recognition performance of the sensor unit.

The processor may increase a safety distance of the vehicle in proportion to a percentage of the degradation in the recognition performance of the sensor unit.

The processor may limit a maximum steering angle of the vehicle in proportion to a percentage of the degradation in the recognition performance of the sensor unit.

The processor may terminate an autonomous driving mode of the vehicle based on a percentage of the degradation in the recognition performance of the sensor unit exceeds a preset allowable limit.

When the recognition performance of the sensor unit is degraded to the preset reference percentage or less, the processor may output at least one of a visual warning signal and an auditory warning signal.

The server may analyze the recognition performance of the sensor unit based on a recognition distance of an external object included in the external object recognition information and a reference recognition distance of an external object included in pre-stored map information.

The server may compare a reference detection range set using pre-stored map information with a detection range calculated using the external object recognition information collected from the sensor unit to analyze the recognition performance of the sensor unit.

The server may reflect at least one of a time when the external object recognition information was collected, a location of the vehicle, illumination information, and weather information to analyze the recognition performance of the sensor unit.

Although the present disclosure has been described above with reference to one or more example embodiments, those skilled in the art will understand that the present disclosure may be modified and changed variously without departing from the spirit and scope of the present disclosure as described in the appended claims.

What is claimed is:

1. An autonomous vehicle comprising:
a sensor;
a transceiver;
one or more processors; and
a memory storing at least one instruction that is configured, when executed by the one or more processors communicating with the memory, to cause the autonomous vehicle to:
receive, from the sensor, vehicle traveling information of the autonomous vehicle and external object recognition information;
transmit, to a server via the transceiver, the external object recognition information;
receive, from the server via the transceiver, an object recognition performance indicator that indicates object recognition performance of the sensor, wherein the object recognition performance is based on the external object recognition information;
determine, based on the object recognition performance indicator indicating that the object recognition performance of the sensor is below a threshold level, an autonomous control strategy for the autonomous vehicle; and
control, based on the autonomous control strategy, an autonomous driving operation of the autonomous vehicle.

2. The autonomous vehicle of claim 1, wherein the at least one instruction is configured, when executed by the one or more processors communicating with the memory, to cause the autonomous vehicle to determine the autonomous control strategy by:
changing, based on the object recognition performance indicator, at least one of: a steering control strategy of the autonomous vehicle, a speed control strategy of the autonomous vehicle, or a braking control strategy of the autonomous vehicle.

3. The autonomous vehicle of claim 1, wherein the at least one instruction is configured, when executed by the one or more processors communicating with the memory, to cause the autonomous vehicle to determine the autonomous control strategy by:
restricting a maximum speed of the autonomous vehicle based on a degree by which the object recognition performance of the sensor has degraded relative to a baseline performance value of the sensor.

4. The autonomous vehicle of claim 1, wherein the at least one instruction is configured, when executed by the one or more processors communicating with the memory, to cause the autonomous vehicle to determine the autonomous control strategy by:
increasing a safe following distance of the autonomous vehicle based on a degree by which the object recognition performance of the sensor has degraded relative to a baseline performance value of the sensor.

5. The autonomous vehicle of claim 1, wherein the at least one instruction is configured, when executed by the one or more processors communicating with the memory, to cause the autonomous vehicle to determine the autonomous control strategy by:
restricting a maximum steering angle of the autonomous vehicle based on a degree by which the object recognition performance of the sensor has degraded relative to a baseline performance value of the sensor.

6. The autonomous vehicle of claim 1, wherein the at least one instruction is configured, when executed by the one or more processors communicating with the memory, to cause the autonomous vehicle to determine the autonomous control strategy by:
disengaging an autonomous driving mode of the autonomous vehicle based on the object recognition performance of the sensor degrading by more than a threshold amount relative to a baseline performance value of the sensor.

7. The autonomous vehicle of claim 1, wherein the at least one instruction is configured, when executed by the one or more processors communicating with the memory, to further cause the autonomous vehicle to:
output, based on the object recognition performance of the sensor being below the threshold level, at least one of a visual warning signal or an auditory warning signal.

8. The autonomous vehicle of claim 1, wherein the object recognition performance of the sensor is based on a comparison between:
a measured distance, indicated by the external object recognition information, to an external object; and
a reference distance, indicated by pre-stored map information, to the external object.

9. The autonomous vehicle of claim 1, wherein the object recognition performance of the sensor is based on a comparison between:
a reference detection range set indicated by pre-stored map information; and
a detection range indicated by the external object recognition information received from the sensor.

10. The autonomous vehicle of claim 1, wherein the object recognition performance of the sensor is based on at least one of: a time when the external object recognition information was received, a location of the autonomous vehicle, illumination information associated with the autonomous vehicle, or weather information.

11. A method performed by an apparatus of an autonomous vehicle, the method comprising:
receiving, from a sensor of the autonomous vehicle, vehicle traveling information of the autonomous vehicle and external object recognition information;
transmitting, to a server via a transceiver of the autonomous vehicle, the external object recognition information;
receiving, from the server via the transceiver, an object recognition performance indicator that indicates object recognition performance of the sensor, wherein the object recognition performance is based on the external object recognition information;
determining, based on the object recognition performance indicator indicating that the object recognition performance of the sensor is below a threshold level, an autonomous control strategy for the autonomous vehicle; and
controlling, based on the autonomous control strategy, an autonomous driving operation of the autonomous vehicle.

12. The method of claim 11, wherein the determining of the autonomous control strategy comprises:
changing, based on the object recognition performance indicator, at least one of: a steering control strategy of the autonomous vehicle, a speed control strategy of the autonomous vehicle, or a braking control strategy of the autonomous vehicle.

13. The method of claim 11, wherein the determining of the autonomous control strategy comprises:
restricting a maximum speed of the autonomous vehicle based on a degree by which the object recognition performance of the sensor has degraded relative to a baseline performance value of the sensor.

14. The method of claim 11, wherein the determining of the autonomous control strategy comprises:
increasing a safe following distance of the autonomous vehicle based on a degree by which the object recognition performance of the sensor has degraded relative to a baseline performance value of the sensor.

15. The method of claim 11, wherein the determining of the autonomous control strategy comprises:
restricting a maximum steering angle of the autonomous vehicle based on a degree by which the object recognition performance of the sensor has degraded relative to a baseline performance value of the sensor.

16. The method of claim 11, wherein the determining of the autonomous control strategy comprises:
disengaging an autonomous driving mode of the autonomous vehicle based on the object recognition performance of the sensor degrading by more than a threshold amount relative to a baseline performance value of the sensor.

17. The method of claim 11, further comprising:
outputting, based on the object recognition performance of the sensor being below the threshold level, at least one of: a visual warning signal or an auditory warning signal.

18. The method of claim 11, wherein the object recognition performance of the sensor is based on a comparison between:
a measured distance, indicated by the external object recognition information, to an external object; and
a reference distance, indicated by pre-stored map information, to the external object.

19. The method of claim 11, wherein the object recognition performance of the sensor is based on a comparison between:
a reference detection range set indicated by pre-stored map information; and
a detection range indicated by the external object recognition information received from the sensor.

20. The method of claim 11, wherein the object recognition performance of the sensor is based on at least one of: a time when the external object recognition information was received, a location of the autonomous vehicle, illumination information associated with the autonomous vehicle, or weather information.
